(19) United States
(12) Patent Application Publication
(10) Pub. No.: US 2014/0258012 A1
(43) Pub. Date: Sep. 11, 2014

(54) Concealed Purchase History

(71) Applicants: Kamal Zamer, Austin, TX (US); Jeremiah Akin, Pleasant Hill, CA (US); James Brett Sowder, Austin, TX (US); Frank Anthony Nuzzi, Pflugerville, TX (US); Jayasree Mekala, Austin, TX (US)

(72) Inventors: Kamal Zamer, Austin, TX (US); Jeremiah Akin, Pleasant Hill, CA (US); James Brett Sowder, Austin, TX (US); Frank Anthony Nuzzi, Pflugerville, TX (US); Jayasree Mekala, Austin, TX (US)

(21) Appl. No.: 13/790,691

(22) Filed: Mar. 8, 2013

(51) Int. Cl. G06Q 30/06

(52) U.S. Cl. CPC G06Q 30/0601
USPC 705/26.1

(57) ABSTRACT

Methods and systems are provided for concealing information regarding products purchased as gifts for others, such as the intended gift recipient. Often, opportunities exist for a gift recipient to inadvertently or intentionally obtain information regarding a gift to be given or already given to them. For example, such information can be readily available via sources such as social media and other websites, as well from account statements. Such information can be omitted from websites, account statements, and the like, at least until such a time that the user wants for the information to be available.

### BACKGROUND

1. Technical Field

The present disclosure generally relates to electronic commerce and, more particularly, relates to methods and systems for concealing a user's purchase history.

2. Related Art

Information regarding purchases made either online or from brick and mortar stores can be provided for others to see. For example, information regarding purchases made online is often posted on a website, such as the purchaser's social media webpage. Such purchases can be automatically posted, such as by an e-commerce seller or by a payment provider. For example, the purchaser can prearrange to have purchases from a particular e-commerce seller (such as an e-commerce seller from which the purchaser frequently makes purchases) posted on the purchaser's social media webpage. The purchaser's social media webpage can be readily accessible to many of the purchaser's friends.

Typically, such purchases are posted on the purchaser's social media webpage to update the purchaser's friends regarding the purchaser's activities. Such posted purchases can also serve as recommendations to the purchaser's friends for products that the purchaser likes. The purchaser may provide comments, e.g., feedback, regarding the products.

As a further example, information regarding such purchases is often provided in account statements. The account statements can be mailed to the purchaser, emailed to the purchaser, or made available online. Such account statements can often be seen by others. For example, family members can see account statements or printed emails left around the house. They can see emails left on a computer screen. People other than the purchaser (such as a spouse or other family members) can have online access to a purchaser's account where the statements can be seen.

### BRIEF DESCRIPTION OF THE DRAWINGS

FIG. 1 is a block diagram of a system for concealing purchase histories, according to an embodiment;

FIG. 2 is a flow chart showing a method for concealing purchase histories, according to an embodiment;

FIG. 3 is a flow chart showing further detail of the method for concealing purchase histories, according to an embodiment; and

FIG. 4 is a block diagram of an example of a computer that is suitable for use in the system for concealing purchase histories, according to an embodiment.

### DETAILED DESCRIPTION

Purchases are often made to obtain products that are to be given as gifts to others. Sometimes, an intended gift recipient undesirably has access to information regarding a gift purchase made by a gift giver or user, as discussed above. This information can include an identification of a product to be given as a gift and/or the price of the product. For example, such information may be available online, such as from an e-commerce website from which the gift was purchased, from a social media website to which a user's purchases are posted, and/or from a payment provider that facilitates such purchases. It can be undesirable to the user for the intended gift recipient to obtain such information, since obtaining the information can spoil the surprise associated with receiving the gift.

As a further example, such information may be available on an account statement of the user. The intended gift recipient can be a family member with access to the user's account statements, financial reports, and the like. Such account statements, financial reports, and the like can include account statements from the e-commerce site, from a payment facilitator such as a credit card company or a payment provider, or from any other entity.

Of course, the user often does not want for the gift recipient to have access to such information. The user typically wants such information to remain secret until the gift has been opened by the recipient. The user typically wants the gift recipient to be surprised when the gift is opened.

According to an embodiment, methods and systems are provided for concealing information regarding products purchased as gifts for others, such as for the intended gift recipient. Such information can be referred to herein as a purchase history. Thus, when opportunities exist that would normally allow the gift recipient to inadvertently or intentionally obtain information (such as purchase history information) regarding a gift, the gift recipient can be inhibited from obtaining the information. For example, such information can be omitted from sources such as social media, e-commerce, and other websites. Such information can be omitted from the user's website. As a further example, such information can be omitted from account statements. Such information can be omitted from websites, account statements, and the like, at least until such a time that the user wants for the information to be available or does not care if the information is available.

The user can desire to limit access to the user's entire purchase history. The user can desire to limit access to a portion of the user's purchase history. For example, the user can desire to limit access to specified information of the users purchase history. The specified information can include an identification of a gift and a price of the gift, for example.

The information can be made available via such source or sources after a predetermined amount of time, on a predetermined date, or otherwise when desired by the user. The user can determine the amount of time for which the information remains unavailable and/or the date on which the information becomes available during a setup process for the concealed purchase history system. The user can determine the amount of time for which the information remains unavailable and/or the date on which the information becomes available on a case-by-case basis, such as for each gift purchased, as desired by the user. The use can make the information available any time that the user desires, regardless of any predetermined amount of time or date.

According to an embodiment, a system can comprise one or more memories storing information about an account for a user. The information can include a purchase history of the user. One or more hardware processors can be in communication with the one or more memories and can be operable to receive a first communication including information regarding a purchase of the user and can store, such as in the one or more memories, the information regarding the purchase of the user.

The one or more hardware processors can receive a second communication including an instruction from the user to conceal specified information regarding the purchase and can store, in the one or more memories, the instruction. The specified information can be a purchase history regarding one purchase or a plurality or purchases. The specified information can be a portion of a purchase history. The one or more hardware processors can provide, from the one or more memories, information regarding the purchase history of the user while concealing the specified information. The entire purchase history can be concealed from specified people, if desired.

The one or more hardware processors can be configured to share the purchase history with a first group of people and to conceal specified information from a second group of people. Thus, the user can designate or pre-determine who the purchase history is shared with and who the purchase history or some portion of the purchase history, e.g., the specified information, is not shared with, e.g., is concealed from. The purchase history or specified information can be shared with some specific people and can be concealed from some specific people.

One or more default lists of people, e.g., groups, can be defined during a setup process. The user can thus simply specify groups later when determining with whom to share the information and with whom to conceal the information.

One or more default events and associated people or groups can be defined, such as during the setup process. For example, events such as birthdays, anniversaries, Valentine's Day, Christmas, and the like can be associated with people or groups of people. Thus, information regarding items that are designated as gifts or automatically assumed to be gifts can be concealed from such people. The user can define items to be designated as gifts during the setup process. For example, flowers, candy, and toys can be designated as gifts. Thus, if flowers are purchased prior to (such as within a specified time period) the user's wife's birthday, then the concealed purchase history system can automatically conceal the purchase from the user's wife, as well as from specified friends of the user's wife who might undesirable revealed the purchase to the user's wife.

The user can choose to never share the concealed purchase history or specified information. For example, the user may not want the gift recipient to ever know the price of the gift. Thus, the price and store from which the gift was purchased can be concealed indefinitely. The user can selectively determine what information is to be concealed, what information is to be revealed, and when the information is to be concealed and revealed. Some information can be revealed (immediately after the purchase or at a later time) while other information regarding a purchase is concealed indefinitely.

The concealed purchase history system can automatically determine that certain items are gifts. For example, the concealed purchase history system can automatically maintain a list of items commonly purchased as gifts and can assume that such items are gift if purchased close to designated events, such as holidays or birthdays.

The concealed purchase history system can use artificial intelligence or heuristics to determine what purchases are likely to be gifts and for whom such purchases are likely to be given as gifts. The concealed purchase history system can learn from experience, e.g., from prior designations of products as gifts, that certain products are likely to be gifts. Such prior designations can be from the user, such that the system can learn what products the user commonly purchases as gifts. Such designations can be from other users of the concealed purchase history system. The concealed purchase history system can prompt the user to conceal purchase information based upon such determinations.

The one or more hardware processors can be configured to initially conceal specified information from a group of people and to subsequently unconceal the specified information from one or more specified members of the group according to instructions from the user. Thus, the specified information be concealed from a predefined group of people at first and then, at a later time, some or all-of the group can receive the specified information.

The user can purchase gifts for several people and can conceal the purchase from all of the people until the user decides to reveal the purchase to selected ones of the people. For example, the user can purchase Christmas gifts for everyone in the user's family. The products (e.g., an identification of the products) can be concealed from all of the recipients until the day after Christmas. However, when the user learns that one of the recipients was not able to attend a Christmas party where the gifts were opened, then the user can delay revealing that particular recipient's present to that particular recipient or to all of the members of the group until that particular recipient has opened the gift.

The GPS of a recipient's mobile device can be used to infer whether or not the recipient has opened the gift. If the recipient has been to the location where the gift is kept at a time when the gift is expected to be opened at that location, then the concealed purchase history system (e.g., the app and/or a server) can assume that the gift has been opened and the concealed purchase information can be unconcealed (revealed), either with or without the concurrence of the user (user authorization can either be required or not be required, at the user's option such as during a setup process). For example, if according to the GPS of the recipients mobile device, the recipient was present at a Christmas party where the gift was expected to be opened by the recipient, then the concealed information regarding the gift can be automatically unconcealed.

The one or more hardware processors can be configured to share information regarding the purchase history via a social network. Revealing the information can comprise sharing the information on one or more social media websites. Revealing the information can comprise sharing the information on the user's website. Revealing the information can comprise sharing the information in any other manner.

For example, the information can be shared via email, text message, a website, an invitation to visit a website, and/or any other method. The information can be accompanied by a message from the user and/or a message from the merchant from whom the gift was purchased. The message from the merchant can include information regarding the gift and/or incentives. Such incentives can include incentives to purchase product related to the gift. For example, if the gift is a bicycle, then the incentives can include a discount on a flat tire repair kit and a discount on a headlight for the bicycle. The message from the merchant can also include information. For example, the information can include information regarding a local bicycling club and an invitation to attend their next get together.

The information and incentives can depend upon the GPS location of the gift recipient. For example, the GPS location of the gift recipient can be used to determine which stores the incentives are for and can be used to determine which bicycling club the gift recipient is invited to join.

The one or more hardware processors can be configured to share information regarding the purchase history via an e-commerce site. The one or more hardware processors can be configured to share information regarding the purchase history via a payment provider website. The one or more hardware processors can be configured to share information regarding the purchase history via any type of website or via any other means.

The one or more hardware processors can be configured to automatically conceal the specified information for gifts. Concealing the specified information can comprise not providing the specified information. For example, the specified information can be concealed by not listing the specified information on a website or account statement.

The one or more hardware processors can be configured to conceal the specified information on card statements, payment processor statement, payment provider statement, bank statement (such as a checking account statement or any other statement), e-commerce statement, or any other type of statement.

The specified information can be revealed to a group of people specified by the user. For example, the group of people to which the specified information is revealed can include friends and family of the user excluding the intended gift recipient.

The specified information can be concealed from a group of people specified by the user. For example, the group of people from which the specified information is concealed can include friends and family of the intended gift recipient. Thus, the group of people from which the specified information is concealed can include people that the user believes may be likely to reveal the specified information to the intended gift recipient.

The specified information can be revealed to a first group of people specified by the user and the specified information can be concealed from a second group of people specified by the user. The first group and the second group can contain any number of people. For example, the first group can contain zero, one, two, three, four, five, ten, twenty, one hundred, or more people. For example, the second group can contain zero, one, two, three, four, five, ten, twenty, one hundred, or more people. Thus, user can specify zero people or can specify one or more people for each group

The first communication can be received before the second communication. Alternatively, the second communication can be received before the first communication. As a further alternative, the first communication and the second communication can be the same communication.

The one or more hardware processors can be further operable to receive a third communication including an instruction to unconceal the specified information. Unconcealing the specified information can make the specified information available to those who could not obtain the specified information when the specified information was concealed. Unconcealing the specified information can make the specified information available to all those people to who such information is normally available.

The specified information can be concealed for a predetermined amount of time. The specified information can be concealed until a predetermined date. The specified information can be concealed until the user unconceals the specified information.

The specified information can include a product price. The specified information can include an identification of the product. The specified information can be all information of first communication regarding the product. The specified information can be any information that the user does not want for someone to see. The specified information can be any information regarding a gift that the user does not want the gift recipient to see.

According to an embodiment, a method can comprise storing, in one or more memories, information about an account for a user, the information including a purchase history of the user. A first communication can be received, via one or more hardware processors. The first communication can include information regarding a purchase of the user. The information regarding the purchase of the user can be stored via the one or more hardware processors in the one or more memories. A second communication including an instruction from the user to conceal specified information regarding the purchase can be received via the one or more hardware processors. Information representative of the instruction can be store via the one or more hardware processors in the one or more memories. Information regarding the purchase history of the user can be provided via the one or more hardware processors and from the one or more memories. The information regarding the purchase history of the user can be provided concealing the specified information

According to an embodiment, a computer program product can comprise a non-transitory computer readable medium. The non-transitory computer readable medium can have computer readable and executable code for instructing one or more processors to perform any of the methods disclosed herein.

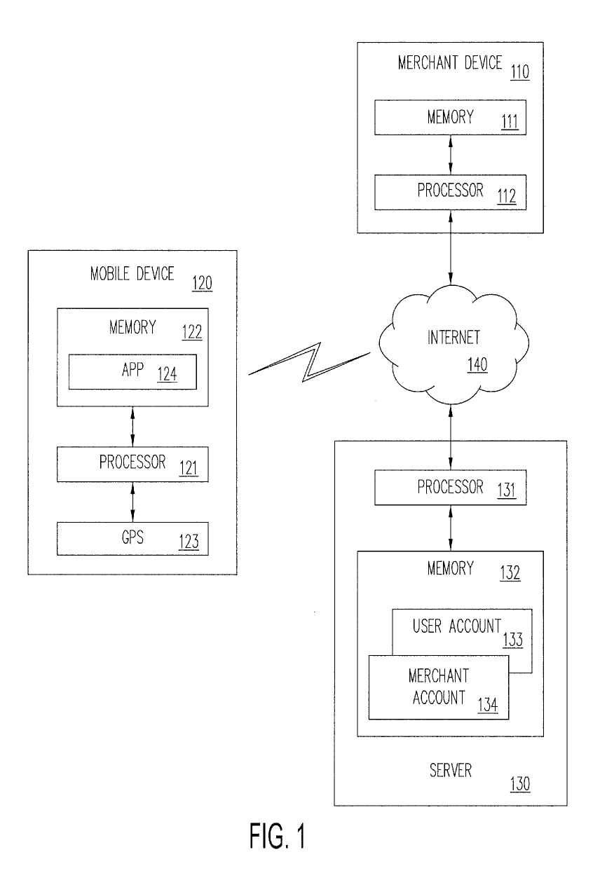

FIG. 1 is a block diagram of a system for concealed a purchase history, according to an embodiment. The system can include a merchant device 110, a mobile device 120, and/or a server 130. The functions discussed herein can be split and/or shared amount the merchant device 110, the mobile device 120, and/or the server 130, as desired.

The merchant device 110 can comprise a merchant checkout terminal, a computer, and/or a server, for example. The merchant device 110 can be at a brick and mortar store or can be part of an online store. The merchant device 110 can include a memory 111 and a processor 112. The merchant device 110 can be used for facilitating purchase transactions.

The mobile device 120 can be carried by the user. The mobile device 120 can comprise a cellular telephone, a smart telephone, a hand held computer, a laptop computer, a notebook computer, or a tablet computer, for example. The mobile device 120 can include a processor 121, a memory 122, and a global positioning system (GPS) 123.

A mobile device such as mobile device 120 can be carried by the gift recipient. The GPS 123 of the mobile device of the gift recipient can be used to infer that the gift has been opened and the concealed information can be revealed in response to such inference, as discussed herein.

The mobile device 120 can be used for routine telephone calls, text messaging, web browsing, and for concealing purchase histories. For example, an app 124 can be stored in the memory 122 and executed by the processor 121. The app 124 can be used for concealing purchase histories. The app 124 can be used to practice the method disclosed herein and/or for facilitating such practice by the user. For example, a conceal purchase history app can be invoked by the user, such as immediately after the user purchases a gift. The concealed purchase history app can ask the user if the user would like to conceal the gift. The concealed purchase history app can ask the user from whom the user would like to conceal the gift. The concealed purchase history app can then cooperate with the social media website, the e-commerce website, the payment provider website, or any other website or entity to effect such concealing of the desired purchase history, e.g., the gift purchase.

The server 130 can comprise a server of a payment provider, such as Paypal, Inc. The server 130 can be a single server or can be a plurality of servers. The server 130 can include one or more processors 131 and a memory 132. The memory 132 can be a memory of the server 130 or a memory that is associated with the server 130. The memory 132 can be a distributed memory. The memory 132 can store a user account 133 and a merchant account 134.

The server 130 can be a server of the social media website, the e-commerce website, the payment provider website, or any other website or entity. The server 130 can be a server of any website or entity that can facilitate concealing or the users purchase history, e.g., gift purchase. The server 130 can comprise a server dedicated to the system for concealing purchase histories.

Generally, the merchant device 110, the mobile device 120, and the server 130 can perform functions discussed herein. That is, at least to some extent, a function that is discussed herein as being performed via one of these devices can be performed by a different one of these devices or by a combination of these devices.

The merchant device 110, the mobile device 120, and the server 130 can communicate with one another via a network, such as the Internet 140. The merchant device 110, the mobile device 120, and the server 130 can communicate with one another via one or more networks, such as local area networks (LANs), wide area networks (WANs), cellular telephone networks, and the like. The merchant device 110, the mobile device 120, the social network 150, and the server 130 can communicate with one another, at least partially, via one or more near field communications (NFC) methods or other short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

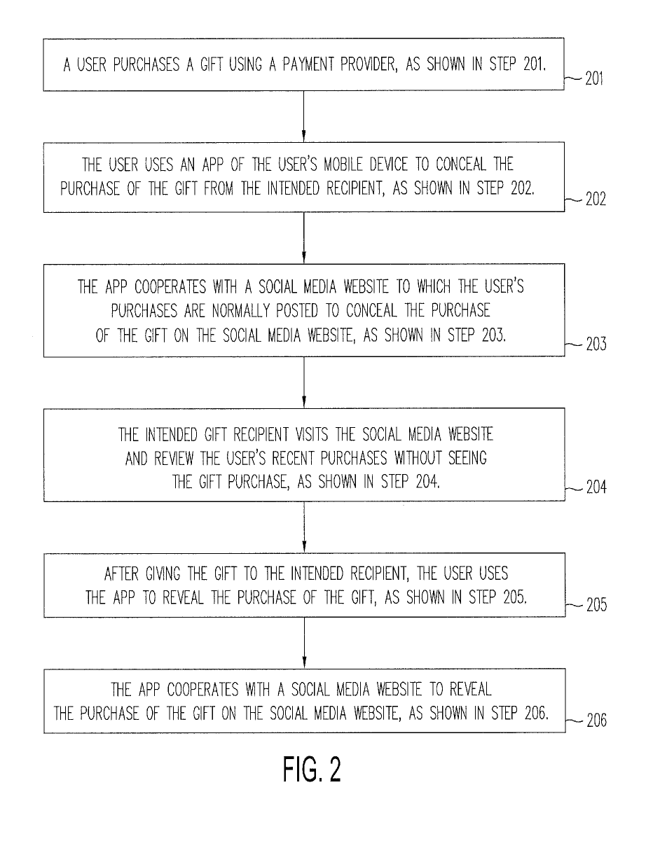

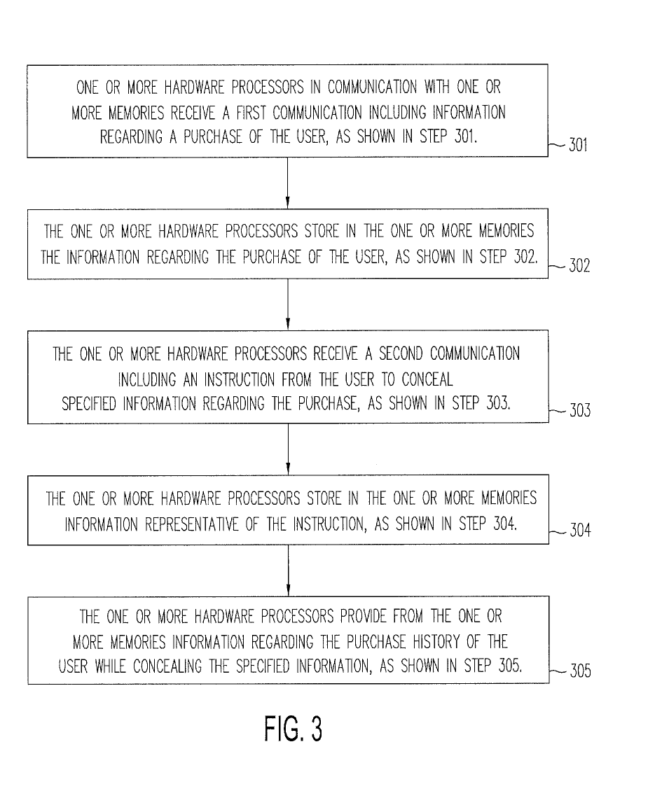

FIGS. 2 and 3 are flow charts that describe examples of operation of the system for concealing a purchase history, according to embodiments thereof. Note that one or more of the steps described herein may be combined, omitted, or performed in a different order, as desired or appropriate.

FIG. 2 is a flow chart showing a method for concealing purchase histories, according to an embodiment. A user can purchase a gift using a payment provider, as shown in step 201. The user can purchase the gift using any desired method of payment. For example, the user can purchase the gift using a credit card, cash, check, or any other method.

The user can use an app of the user's mobile device to conceal the purchase of the gift from the intended recipient, as shown in step 202. For example, the user can tap an icon on a screen of the user's mobile device 120 to invoke the app. Alternatively, the app can be on the user's desktop computer. As a further alternative, the app can be resident on a website, such as a website when the purchase history of the user is store, maintained, and/or displayed.

The app can cooperate with a social media website to which the user's purchases are normally posted to conceal the purchase of the gift on the social media website, as shown in step 203. The app can cooperate with a payment provider website or any other website to conceal the purchase of the gift.

The intended gift recipient can visit the social media website and review the user's recent purchases without seeing the gift purchase, as shown in step 204. The intended gift recipient can visit the payment processor website or any other website to review the user's recent purchases. According to an embodiment, the purchase of the gift is not listed on any website where the intended gift recipient can view it.

After giving the gift to the intended recipient, the user can use the app to reveal the purchase of the gift, as shown in step 205. The user can invoke the app and can cancel the concealment of the purchase history. Alternatively, cancellation of the concealment of the gift can be present, such as via the app at the time of concealing the purchase of the gift or such as via the app or any other mechanism during a set up procedure for the method for purchase history concealment.

The app can cooperate with a social media website to reveal the purchase of the gift on the social media website, as shown in step 206. Thus, the recipient can see the purchase after the recipient receives or opens the gift. Others, as determined by the user, could not see the purchase until the recipient could see the purchase. Others, as determined by the user, could see the purchase all along. Thus, the user controls who can see information regarding the purchase, who cannot see the information, when each person can see the information, and what the information is.

FIG. 3 is a flow chart showing further detail of the method for concealing purchase histories, according to an embodiment. One or more hardware processors in communication with one or more memories can receive a first communication including information regarding a purchase of the user, as shown in step 301. The one or more hardware processors and the one or more memories can part of the merchant device 110, part of the server 130, part of the mobile device 120, part of any other server or device. The first communication can be from an app of the mobile device 120, for example.

The one or more hardware processors can store in the one or more memories the information regarding the purchase of the user, as shown in step 302. The one or more hardware processors receive a second communication including an instruction from the user to conceal specified information regarding the purchase, as shown in step 303. The second communication can be from an app of the mobile device 120, for example.

The one or more hardware processors store in the one or more memories information representative of the instruction, as shown in step 304. The one or more hardware processors provide from the one or more memories information regarding the purchase history of the user while concealing the specified information, as shown in step 305.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

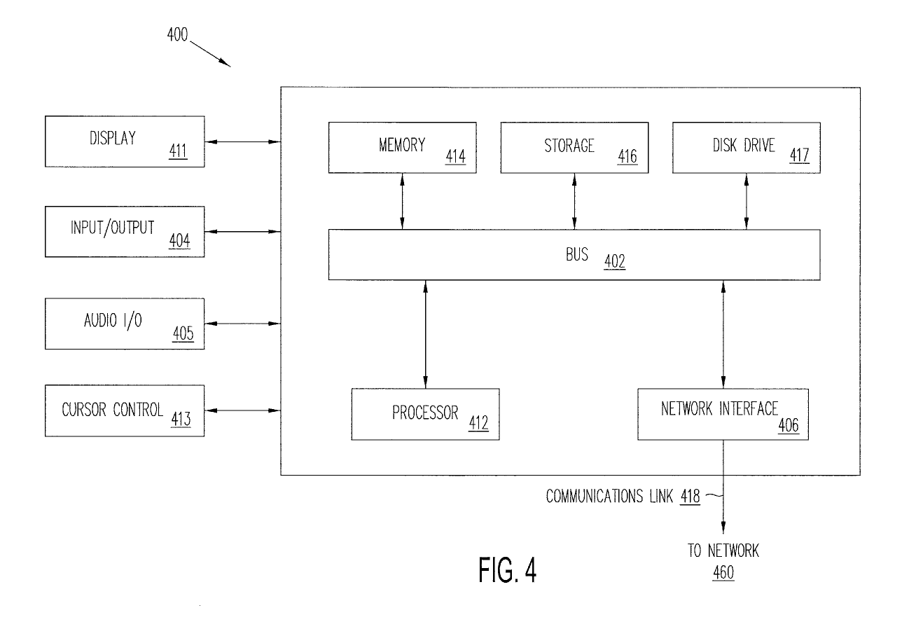

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used herein, the term “store” can include any business or place of business. The store can be a brick and mortar store or an online store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

As used herein, the term “purchase history” can refer to information regarding a single purchase. As used herein, the term “purchase history” can refer to information regarding a plurality of purchases. In either event, the information can include an identification of any product(s) purchased. The information can include the name of the product(s), the manufacturer of the product(s), the store from which the product(s) were purchased, the date on which the product(s) were purchased, and/or the price of the product(s). Other information can be included in the product history. According to an embodiment, the user can conceal and/or reveal specified information of the purchase history. Such information can be specified by the user.

Embodiments can provide systems and methods for limiting sharing of information regarding purchases to specified people. Such limiting can be performed to inhibit a gift recipient from learning what is going to be received prior to receiving the gift. Thus, the user can be better assured that the gift recipient will be surprised by the gift. Such limiting can be performed for any other reason.

Embodiments can provide systems and methods for delaying when purchases are shown on websites, account statements, and the like. The purchase can be delayed for some website visitors and not for other website visitors, as determined by the user.

Embodiments can facilitate such limiting of information for a specified amount or period of time. Thus, calendar based purchase secrecy can be provided. Embodiments can facilitate such limiting regarding information other than purchase information. For example, calendar information, travel information, financial transactions, investments, and/or any other desired information can similarly be limited with respect to time, people having access to the information, and/or any other criteria.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
one or more memories storing information about an account for a user, the information including a purchase history of the user;
one or more hardware processors in communication with the one or more memories and operable to:
receive a first communication including information regarding a purchase of the user;
store, in the one or more memories, the information regarding the purchase of the user;
receive a second communication including an instruction from the user to conceal specified information regarding the purchase;
store, in the one or more memories, the instruction; and
provide, from the one or more memories, information regarding the purchase history of the user while concealing the specified information.

2. The system of claim 1, wherein the one or more hardware processors are configured to share the purchase history with a first group of people and to conceal the specified information from a second group of people.

3. The system of claim 1, wherein the one or more hardware processors are configured to initially conceal the specified information from a group of people and to subsequently unconceal the specified information from one or more specified members of the group according to instructions from the user.

4. The system of claim 1, wherein the one or more hardware processors are configured to share information regarding the purchase history via a social network.

5. The system of claim 1, wherein the one or more hardware processors are configured to share information regarding the purchase history via an e-commerce site.

6. The system of claim 1, wherein the one or more hardware processors are configured to automatically conceal the specified information for gifts.

7. The system of claim 1, wherein the one or more hardware processors are configured to conceal the specified information on card statements.

8. The system of claim 1, wherein the specified information is revealed to a group of people specified by the user.

9. The system of claim 1, wherein the specified information is concealed from a group of people specified by the user.

10. The system of claim 1, wherein the specified information is revealed to a first group of people specified by the user and the specified information is concealed from a second group of people specified by the user.

11. The system of claim 1, wherein the first communication is received before the second communication.

12. The system of claim 1, wherein the second communication is received before the first communication.

13. The system of claim 1, wherein the first communication and the second communication are the same communication.

14. The system of claim 1, wherein the one or more hardware processors are further operable to receive a third communication including an instruction to unconceal the specified information.

15. The system of claim 1, wherein the specified information is concealed for a predetermined amount of time.

16. The system of claim 1, wherein the specified information is concealed until a predetermined date.

17. The system of claim 1, wherein the specified information is product price.

18. The system of claim 1, wherein the specified information is an identification of the product.

19. The system of claim 1, wherein the specified information is all information of first communication regarding the product.

20. A method comprising:
storing, in one or more memories, information about an account for a user, the information including a purchase history of the user;
receive, via one or more hardware processors, a first communication including information regarding a purchase of the user;
storing, via the one or more hardware processors in the one or more memories, the information regarding the purchase of the user;
receiving, via the one or more hardware processors, a second communication including an instruction from the user to conceal specified information regarding the purchase;
storing, via the one or more hardware processors in the one or more memories, the instruction; and
providing, via the one or more hardware processors, from the one or more memories, information regarding the purchase history of the user while concealing the specified information.

21. A computer program product comprising a non-transitory computer readable medium having computer readable and executable code for instructing one or more processors to perform a method, the method comprising:
storing information about an account for a user, the information including a purchase history of the user;
receive a first communication including information regarding a purchase of the user;
storing the information regarding the purchase of the user;
receiving a second communication including an instruction from the user to conceal specified information regarding the purchase;
storing the instruction; and
providing information regarding the purchase history of the user while concealing the specified information.
